(19) United States
(12) Patent Application Publication
(10) Pub. No.: US 2026/0175524 A1
(43) Pub. Date: Jun. 25, 2026

(54) COMPONENT AND PROCESS FOR THE MANUFACTURE OF A COMPONENT

(71) Applicant: PARAT Technology Group GmbH, Neureichenau (DE)

(72) Inventor: Martin KREMSREITER, Neureichenau (DE)

(21) Appl. No.: 19/240,434

(22) Filed: Jun. 17, 2025

(30) Foreign Application Priority Data
Jun. 19, 2024 (DE) 10 2024 117 329.7
Jul. 24, 2024 (DE) 10 2024 121 045.1
Dec. 23, 2024 (DE) 10 2024 139 628.8

(51) Int. Cl. B29C 69/02; B29K 105/04; B29L 31/30; B32B 5/20; B32B 27/06

(52) U.S. Cl. CPC B29C 69/02; B32B 5/20; B32B 27/065; B29K 2105/048; B29L 2031/3041; B32B 2250/03; B32B 2250/24; B32B 2250/40; B32B 2307/72; B32B 2307/7376; B32B 2605/003

(57) ABSTRACT

A method for manufacturing a structural element, including the following steps: a) providing a first film-like substrate with a first outer contour; b) providing a second film-like substrate with a second outer contour, which has an opening; c) providing an openable and closable tool having two tool halves, wherein the second tool half has a filling opening, wherein the first tool half has a first inner contour shaped complementary to the first outer contour and the second tool half has a second inner contour shaped complementary to the second outer contour; d) arranging the two substrates in the open tool so that the opening and the filling opening are aligned with each other; e) closing the tool; f) providing granular starting material formed as loose particles of a foamable particle foam; and g) feeding the particles through the filling opening and the through-opening into a cavity bounded by the two substrates.

The invention relates to a method for manufacturing a flat structural element according to claim 1.

The invention relates in particular to a method for manufacturing a flat structural element in a lightweight sandwich construction with a high-quality surface.

Such methods have been developed by the applicant for decades and are carried out on a large scale.

The following German patent applications by the applicant are cited as examples only:

DE 10 2018 117 337, DE 10 2017 109 953, DE 10 2016 112 290 A1, DE 10 2013 018 694 A1, DE 10 2013 008 592 A1, DE 10 2013 005 523 A1, DE 10 2013 008 364 A1, DE 10 2015 111 052 A1 and DE 10 2012 017 698 A1, the contents of which are hereby incorporated into the present patent application to avoid repetition.

The methods used by the applicant to date for manufacturing such a flat structural element mainly involve bonding thermoplastic deep-drawn films with polyurethane foam compounds.

However, for several years now, the applicant has also been developing and using methods in which particle foams are baked together. Reference is made, for example, to German patent applications DE 10 2018 123 703 A1, DE 10 2019 117 661 A1, DE 10 2019 109 820 A1, DE 10 2019 109 823 A1 and DE 10 2019 109 824 A1, the content of which is hereby also included in the content of the present patent application to avoid repetition.

Based on this, the invention is based on the object of specifying a method for manufacturing a flat structural element that meets the requirements for low weight and high rigidity and can be manufactured inexpensively.

The invention achieves this object by means of the features of claim 1.

The principle of the invention consists primarily in using an expandable particle foam instead of the two-structural element polyurethane foams used to date.

Suitable expandable particle foams include, for example, particle foams made of EPS, EPE, and EPP. These are particle foams which, in their fully or finally foamed and cured state, can have densities in the range of typically 15 kg/m3 to 200 kg/m3.

According to the invention, a first film-like substrate is first provided. This can be, for example, a deep-drawable film, e.g., made from a co-extrudate of ABS or PMMA, or a co-extrudate of ABS, polycarbonate, and PPMA. This can have a wall thickness of between 0.2 and 13 mm, for example. The film can, for example, be deep-drawn in a first mold. However, the first substrate used can also be provided by a thin skin, a thin film, or another flat material. The first substrate does not have to be deep-drawn.

According to the invention, the first substrate is arranged in a first mold half of a foaming mold.

According to the invention, a second substrate is also provided. This can also be a deep-drawn film or a plastic injection molded part. The second substrate is arranged in a second mold half.

The first mold half has an inner contour that is shaped to fit the outer contour of the first substrate. The second mold half has an inner contour that is shaped to fit the outer contour of the second substrate.

The first substrate and the second substrate can each be shell-shaped. The second substrate can also be formed by a ring body, for example.

The first substrate is formed over its entire surface. It comprises, in particular, a base wall and side wall sections that are bent relative to the base wall or project from the base wall. The second substrate may also be shell-shaped. In particular, it may also have a base wall and side wall sections that project from it. However, the second substrate may also be ring-shaped.

The second substrate has at least one opening, which is referred to as a through-opening. The second mold half has a filling opening through which particles can be fed into a cavity or at least partially bounded cavity formed by the two substrates with their respective inner surfaces. Particles are fed in particular by means of compressed air.

The through-opening in the second substrate is brought into alignment with the filling opening during the arrangement of the substrate on the second tool half in alignment with the filling opening.

Since, according to the method of the invention, a first substrate and a second substrate are provided, which in particular both already have a predetermined geometry and only need to be inserted into the tool, it is possible that functionalized areas may already be arranged on the first substrate and/or on the second substrate. The functionalized areas may comprise, for example, ribs, strip-like thickenings, screw fastening areas, convex thickenings, receiving areas, struts, domes, or the like.

The invention also encompasses cases in which the first substrate and/or the second substrate have a functional element, e.g., a metallic or textile insert, or, for example, a transverse belt, in particular in the manner of a tie rod.

The method according to the invention provides that granular starting material is provided in the form of loose particles of a foamable particle foam. Materials known as expandable particle foams are suitable. In particular, this refers to expandable particle foams made of EPS, EPE, or EPP, or also expandable PEEK. A further definition is given below.

The granular starting material can be provided in the form of small beads or pearls, or in the form of granular particles of other regular or irregular shapes and geometries. The starting material is particularly pourable.

The particles are loosely present in the granular starting material, i.e., in particular, they are not yet firmly bonded to one another.

According to a variant of the invention, partially foamed particles are fed into the cavity. This means that the particles are not yet completely foamed when they are fed in.

For example, according to the invention, it may be provided that, based on a foaming or expansion process of 0 to 100% starting from the volume of the particles of the starting material up to the volume of the particles in the finished foamed state, partial foaming of between 30 and 95% takes place. The term “partial foaming” includes, in particular, embodiments of the invention in which the step of additional foaming of the particles is carried out in the cavity until the particles reach a final foamed state.

The step of partial foaming, known as pre-foaming, takes place in particular—but not necessarily—at a location remote from the mold in which the substrates are arranged. Furthermore, the partial foaming of the particles can advantageously be carried out in an oven, in particular in an infrared oven.

According to another variant of the invention, completely foamed particles are fed into the cavity.

According to the method of the invention, the pre-foamed or fully foamed particles can be transferred into the cavity. The transport of the particles can, for example, be carried out immediately after the performance of a step of partial foaming of the particles. However, it can also be carried out at a time interval after the performance of a step of partial foaming of the particles.

The transfer and/or arrangement or positioning of the particles in the cavity can be carried out mechanically, in particular pneumatically, automatically, or manually.

According to the invention, the tool is closed before the particles are fed in. For this purpose, for example, a first tool half can move against a second tool half and close or essentially close a receiving space or accommodation space for the particles—as well as for the substrates located in the tool.

The tool is closed at least to the extent that no particles can escape from the interior of the tool to the outside.

After the tool has been filled with particle foam particles and closed, the tool is heated. The invention particularly encompasses cases in which the tool is subjected to temperature cycling and can reach a temperature above the melting temperature of the particle foam as well as a temperature below this melting temperature. Within these temperature ranges, the mold can be operated along temperature ramps.

According to the invention, heating the mold causes heat to be transferred through the two substrates into the cavity. The introduction of this heat energy causes the particles to bake together to form a completely foamed particle foam. The baking step may include final foaming of the particles that have already been partially foamed. The particles melt and bond together.

According to the invention, in particular, no steam is introduced into the cavity. In prior art methods, the particles are foamed from particle foam with the aid of steam. The invention, on the other hand, does not require the use of steam. This makes it possible, in particular, to produce completely dry, i.e., steam-free structural elements.

For example, electrical or metallic structural elements can also be foamed in the cavity.

If not all particles have been foamed completely and only partially foamed particles have been introduced into the cavity, a final foaming process of the particles can also be carried out under temperature control. The particles expand to their maximum circumference or maximum volume and bake or sinter together. At the same time, the particle foam mass bonds with the two substrates. The activation of the baking step and the activation of the residual foaming step are controlled by the mold temperature.

It is important that, apart from the supply of heat energy by heating the mold and by heat transfer across the substrates and into the cavity, no further energy is introduced into the cavity. In particular, in contrast to conventional particle foam manufacturing processes, no water vapor is introduced into the cavity.

According to the invention, energy is only introduced into the cavity by heating the mold.

After the tool has been closed and heated, the tool can, according to a variant of the invention, perform an additional tool stroke and the tool can be closed further. This allows the heated, melted particle foam mass to be compressed.

According to the invention, the particle foam mass is then allowed to harden. As a result of this hardening process, the particle foam mass forms a permanent, solid bond with the two substrates.

The invention also encompasses cases in which the first substrate and/or the second substrate are provided with a corresponding chemical, e.g. in the form of an adhesive primer, in order to optimize the bond between the substrates and the particle foam mass or the formation of the bond between the substrates and the particle foam mass.

After allowing the particle foam mass to cure, the mold can be opened and the molded part thus formed can be removed. The molded part thus formed represents the structural element to be manufactured according to the invention, or can be developed into such a structural element by subsequent processing steps.

### Definition of Expandable Particle Foam:

The following materials, for example, are considered expandable particle foams within the meaning of this patent application:

The abbreviation EPS refers to expandable polystyrene. This is known, for example, under the brand name Styropor and can be obtained, for example, from Metz EPS-Hartschaumzuschnitte in 74376 Gemmrigheim.

Expandable polyethylene (EPE) is also considered to be particle foam within the meaning of this patent application. Finally, expandable polypropylene (EPP) is also considered to be well suited for the purposes of the invention.

In particular, the term particle foam within the meaning of the present patent application includes thermoplastic particle foams. These can have granules, in particular microgranules, as their starting material, for example with particle diameters in the range of between 0.1 and 5 mm, and preferably particles with a diameter of approximately 1 mm.

Blowing agents are preferably arranged in the granular starting material particles of the particle foam. These can be activated thermally and/or by chemicals, for example also by the action of water vapor, in order to trigger the pre-foaming process.

The process of residual foaming, i.e., the final foaming of already pre-foamed particles to form finally foamed particles, is also referred to as sintering in the present patent application in accordance with the German Patent and Registration Act.

Pentane, which is polymerized into the granular particles, is one possible blowing agent for polystyrene particle foam particles. As soon as the particles are exposed to temperatures above 100° C., the blowing agent can evaporate and expand the thermoplastic base material into polystyrene foam particles.

According to the invention, the second foaming stage can take place in the mold, wherein the mold temperature is selected so that the blowing agent can evaporate completely and the particles can foam completely.

In addition to EPS (expandable polystyrene), ABS can also be used for the invention.

Particle foams for use with the invention can also be provided from expandable copolymers. Such materials are available, for example, from Sunpor or BASF.

Expandable PEEK (polyetheretherketone) can also be considered as a starting material for the particle foam that can be used in the invention. This is available, for example, under the trade names Gatone or Victrex.

The method according to the invention is used to produce a structural element with a high-quality surface. A high-quality surface can, for example, be particularly resilient, e.g., have a high degree of impact resistance, and furthermore be particularly suitable for outdoor applications. In particular, a high-quality surface can have properties as required for so-called Class A surfaces.

The invention relates to a method for manufacturing a structural element with a flat structure. The term “surface-” means that the structural element extends considerably longer along a surface in the x and y directions than in a z direction perpendicular thereto. The surface can be flat or curved in space, even multiple times, and can take on any desired shape.

The invention also relates to a method according to claim 2.

The invention is based on the object of specifying a method for manufacturing a flat structural element that meets the requirements for low weight and high rigidity and can be manufactured inexpensively.

The invention achieves this object by means of the features of claim 2.

The principle of the invention is best understood in light of the above description of the invention according to claim 1, which applies analogously.

According to an advantageous embodiment of the invention, the first substrate and/or the second substrate are provided from a deep-drawn film. This allows the use of conventional structural elements of a structural element that have already been extensively tested and, in particular, enables the provision of a high-quality surface for the structural element.

According to an advantageous embodiment of the invention, the first substrate or the second substrate is provided by a plastic injection molded part. This enables particularly inexpensive production of structural elements according to the invention, especially in small series.

According to a further advantageous embodiment of the invention, the first substrate is formed continuously over the entire surface. This enables the provision of a structural element with a surface that can be used, for example, in outdoor applications and, in particular, does not require any post-processing.

According to a further advantageous embodiment of the invention, the second substrate is formed continuously over its entire surface, with the exception of the through-opening or, if several through-openings are provided, with the exception of these several through-openings. This makes it possible to provide a structural element with two high-quality surfaces. The second substrate can, with its outer side, in particular if the structural element forms a vehicle part designed for outdoor applications, provide the inner surface of the structural element in the assembled state. The outer side of the second substrate also requires little or no post-processing after the structural element has been manufactured.

According to a further advantageous embodiment of the invention, the second substrate is formed by a ring body. This enables a particularly stable construction of a structural element to be manufactured.

According to a further advantageous embodiment of the invention, the method according to the invention comprises the following step:

Processing the molded part into a structural element.

Various processing methods can be used as processing steps. These include, for example, separating or cutting off parts or areas of the molded part, if necessary, and also cutting off or separating sections of the substrate. This also includes, for example, a cleaning step and/or a surface treatment step, in particular on the outside of the substrate, for example roughening or polishing or smoothing the surface, and, if necessary, applying an additional layer or film, for example an additional functional layer.

According to a further advantageous embodiment of the invention, the first substrate and/or the second substrate have a wall thickness of between 0.2 mm and 13 mm, in particular between 1 mm and 5 mm. This embodiment of the invention also allows the use of conventional films, which have been tested in numerous composite materials and whose deep-drawing properties and surface properties are sufficiently known and researched.

According to a further advantageous embodiment of the invention, the cured particle foam mass has a wall thickness between 0.5 cm and 2 cm, in particular between 0.8 cm and 1.5 cm. These wall thickness ranges are predominantly used for the structural elements in question, wherein the wall thicknesses may also be partially greater than specified and also smaller than specified. The values specified may therefore be average values in particular. For example, greater wall thicknesses are required if screw-on domes or fastening areas or reinforcement areas are provided, which depend on the individual geometry of the structural element to be manufactured.

The wall thickness of the cured particle foam mass is calculated and designed depending on the required strength of the manufactured structural element. Despite the relatively large wall thicknesses, the finished structural element can be very lightweight.

According to a further advantageous embodiment of the invention, the structural element is designed as a vehicle part for a motor vehicle, or for a commercial vehicle, or for a caravan vehicle, and is, for example, an interior trim part, or a cargo compartment cover, or a trim part, or an engine hood, or a roof element, or a roof segment, hood, sleeping compartment extension, or a vehicle wall or vehicle wall element.

According to a further advantageous embodiment of the invention, the granular starting material comprises expandable EPS, expandable EPP, or expandable PEEK. These are all materials that are foamable, i.e., expandable, and which, according to the invention, are suitable for being initially only partially foamed or expanded in order to subsequently undergo a final foaming or final expansion step in a mold.

According to a further advantageous embodiment of the invention, the method comprises the step:

m) positioning reinforcing elements, in particular of the type of tensile anchors, for example of the type of tapes, in the lower mold, wherein, after the particles have been introduced into the mold, the particles envelop the reinforcing elements.

According to this advantageous embodiment of the invention, the finally foamed, expanded particle foam mass is reinforced or stiffened by reinforcing elements. These are designed in particular so that they can transmit tensile forces in a direction transverse to the planar extension of the structural element. This increases the stiffness of the structural element. The invention also encompasses cases in which the reinforcing elements extend along the direction of extension of the flat structural element. For example, flat structures such as mats, fabrics, knitted fabrics, etc. made of reinforcing fibers, for example glass fibers, carbon fibers, aramid fibers, basalt fibers, or other suitable reinforcing fibers, can be inserted into the cavity before filling with particles.

According to an advantageous embodiment of the invention, one of the two substrates is shell-shaped and has a collar surrounding a through-opening, wherein, as a result of step f), the other of the two substrates can be inserted into the through-opening. This embodiment of the invention enables the production of a structural element with a first substrate and a second substrate, wherein one of the two substrates has a collar and the other of the two substrates can be inserted or pressed into a through-opening formed by the collar. This facilitates the production of the structural element in an economical manner and enables optimized implementation of the method according to the invention.

According to an advantageous embodiment of the invention, after step f) has been carried out, the collar of one substrate surrounds an edge of the other substrate. This embodiment of the invention enables particularly advantageous implementation of the method according to the invention.

According to an advantageous embodiment of the invention, a venting gap remains between the collar of one substrate and the edge of the other substrate after the tool is closed. This design ensures that the cavity formed between the two substrates can be filled with particles of particle foam easily, quickly, and safely. The vent gap can have any geometry and allows the compressed air to escape during filling, thus enabling the cavity to be filled at very high pressure.

According to an advantageous embodiment of the invention, both substrates are shell-shaped and nest together. This design enables particularly optimized implementation of the method according to the invention.

The invention also relates to a method according to claim 23.

Again, the invention is based on the object of specifying a method for manufacturing a flat structural element that meets the requirements of low weight and high rigidity and can be manufactured inexpensively.

The invention achieves this object by means of the features of claim 23.

The principle of the invention essentially consists in providing a tool closure in two steps, in contrast to and/or in addition to the method described above.

First, the tool is moved to a pre-closing position in which the two substrates form a cavity between them that can be filled with particles. After filling the cavity and heating the two tool halves, the particles melt or soften. After a specified time and/or after passing through a predetermined temperature profile, the tool is moved from the pre-closing position to a final closing position. When the tool has reached the final closing position and the melted or softened particles have been compressed, the tool is heated further until the particles melt completely or bake together. The tool heating process can then be stopped or the tool can be cooled and the particle foam mass hardens. The tool can then be opened and the molded part removed.

According to this teaching, the mold performs a closing movement with at least two strokes. A first closing stroke is performed until a pre-closing position is reached. After filling the cavity with particles and melting the particles, a further compression stroke is performed to compress the particle mass. The compression stroke is performed at a point in time when the particles have already melted, or are partially melted or softened.

This enables the tool to be closed with only low closing forces. As a result, the tool is not subjected to the stresses that would be necessary to achieve comparable compression of the particles if the particles were not melted or softened. This increases the service life of the tool, for example. In addition, this invention enables very high densities of the particle foam mass to be achieved. Finally, the tool can be designed to be less complex.

According to an advantageous embodiment of the invention, step j) results in the particles being compressed to a density that is at least or approximately twice as high, in particular at least or approximately three times as high, and further in particular at least or approximately four times as high as the density of the particles in the uncompressed state. This embodiment of the invention makes it possible to achieve very high densities in the particle foam mass and thus to produce very dimensionally stable, compact structural elements.

According to an advantageous embodiment of the invention, as a result of carrying out step j), the particles are compressed to a density of more than or approximately 100 kg/m³, in particular to a density of more than or approximately 150 kg/m³, and further in particular to a density of more than or approximately 200 kg/m³. This embodiment of the invention makes it possible to achieve very high densities in the particle foam mass and thus to achieve very dimensionally stable, compact structural elements.

According to a further aspect, the invention relates to a flat structural element according to claim 26.

The invention is based on the object of specifying a structural element which has high strength and load-bearing capacity despite its low weight and can be produced inexpensively.

The invention achieves this object by means of the features of claim 26.

To avoid repetition, reference is made to the previous explanations of claims 1 to 25 for the explanation and description of the features of claim 26 and for the explanation of the invention according to claim 26.

According to the invention, a structural element is provided whose surface is provided on all sides, or essentially on all sides, by the outer surface of the first substrate or the second substrate. This allows efficient, inexpensive production of a lightweight sandwich structural element.

According to one embodiment of the invention, the first substrate and/or the second substrate is provided by a film with a wall thickness between 0.05 mm and 13 mm, in particular between 1 mm and 5 mm. This embodiment enables particularly simple production and the provision of a stable, robust structural element that is lightweight and has a high-quality surface.

According to a further embodiment of the invention, the particle foam is foamed against the two substrates. This embodiment of the invention enables a particularly light, stable, and rigid sandwich construction of a structural element.

According to a further embodiment of the invention, the first substrate is formed from a deep-drawn part. This embodiment of the invention enables the use of a simple manufacturing process and a stable construction of a structural element according to the invention.

According to a further embodiment of the invention, the second substrate is formed from a deep-drawn part. This embodiment of the invention allows conventional manufacturing methods for substrates to be used.

According to a further embodiment of the invention, the first substrate is provided by a plastic injection molded part. This embodiment of the invention allows conventional manufacturing methods for substrates to be used.

According to a further embodiment of the invention, the second substrate is provided by a plastic injection molded part. This embodiment of the invention allows conventional manufacturing methods for substrates to be used.

According to a further embodiment of the invention, the first substrate consists of a thermoplastic material and/or the second substrate consists of a thermoplastic material, and in particular ABS or PMMA. This embodiment of the invention allows conventional manufacturing methods for substrates to be used.

According to a further embodiment of the invention, the first substrate is formed continuously over the entire surface. This embodiment of the invention allows conventional starting materials for substrates to be used.

According to a further embodiment of the invention, the second substrate is formed continuously over its entire surface with the exception of at least one opening. This embodiment of the invention enables the production of a structural element whose surface no longer requires any further processing.

According to a further embodiment of the invention, the second substrate is formed by a ring body. This embodiment of the invention enables the production of a structural element that requires at most minor post-processing.

According to a further embodiment of the invention, the structural element is designed as a vehicle part for a motor vehicle or for a commercial vehicle or for a caravan vehicle, such as an interior trim part, a load compartment cover, a trim part, an engine hood, a roof element or roof segment, a hood, a sleeping compartment extension, a vehicle wall, or a vehicle wall element. This configuration of the invention enables the provision of a very robust vehicle part.

According to a further embodiment of the invention, the starting material is provided in the form of expandable EPS, PP, PPSU, PSU, ABS, or PEEK. This embodiment of the invention enables the provision of a very compact, lightweight vehicle part that is easy to manufacture.

According to an advantageous embodiment of the invention, the particle foam has a density of more than or approximately 100 kg/m³, in particular a density of more than or approximately 150 kg/m³, and more particularly a density of more than or approximately 200 kg/m³. This embodiment of the invention makes it possible to achieve very dimensionally stable and rigid structural elements.

Further advantages of the invention result from the subclaims and from the following description of the embodiments shown in the drawings.

The drawings show in:

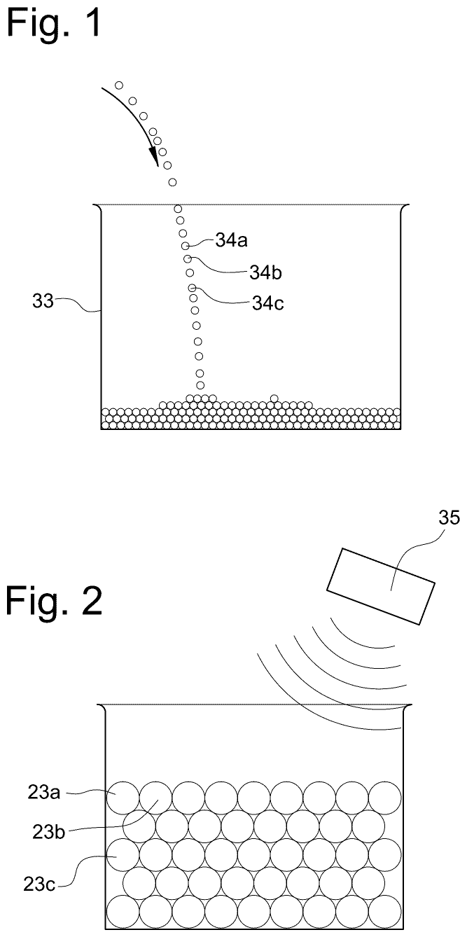

FIG. 1 a schematic diagram of a container into which granular starting material for a particle foam is filled,

FIG. 2 the container of FIG. 1, wherein the introduced particles have been foamed under the influence of infrared radiation,

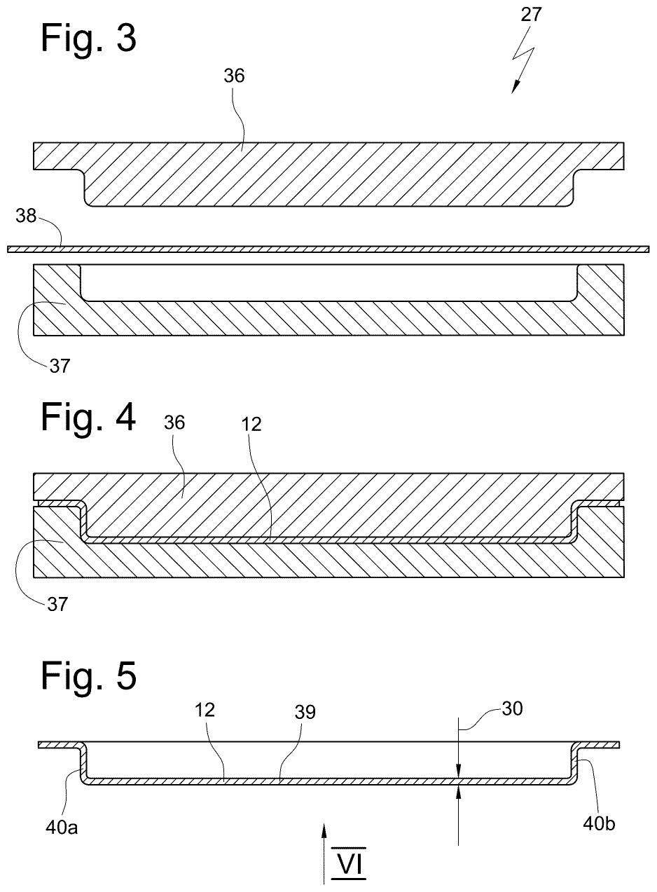

FIG. 3 a first substrate in a flat position and a first deep-drawing tool in an open position,

FIG. 4 in a representation according to FIG. 3, the tool in the closed state and the deep-drawn first substrate,

FIG. 5 the first deep-drawn substrate of FIG. 4 in a partially cut-away view,

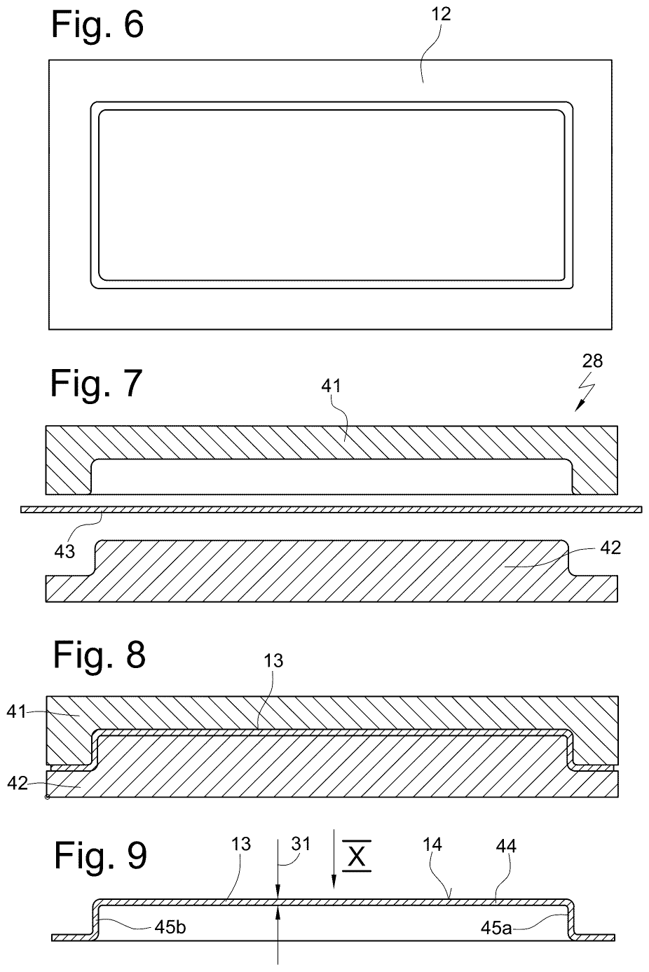

FIG. 6 the first substrate according to view arrow VI of FIG. 5 in top view,

FIG. 7 a second deep-drawing tool and a second substrate that is still in a flat position,

FIG. 8 the closed second deep-drawing tool according to FIG. 7 and the deep-drawn second substrate,

FIG. 9 the deep-drawn second substrate of FIG. 8 in a partially cut-away view,

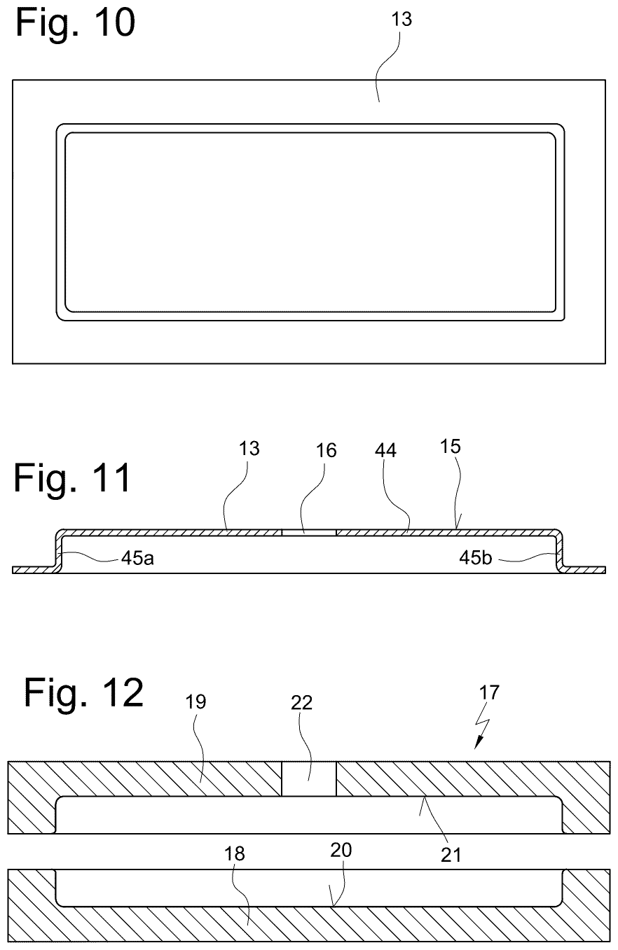

FIG. 10 a top view of the deep-drawn second substrate approximately along the viewing arrow X in FIG. 9,

FIG. 11 the deep-drawn second substrate after a through-opening has been made,

FIG. 12 the tool consisting of two tool halves with a filling opening in a partially open state,

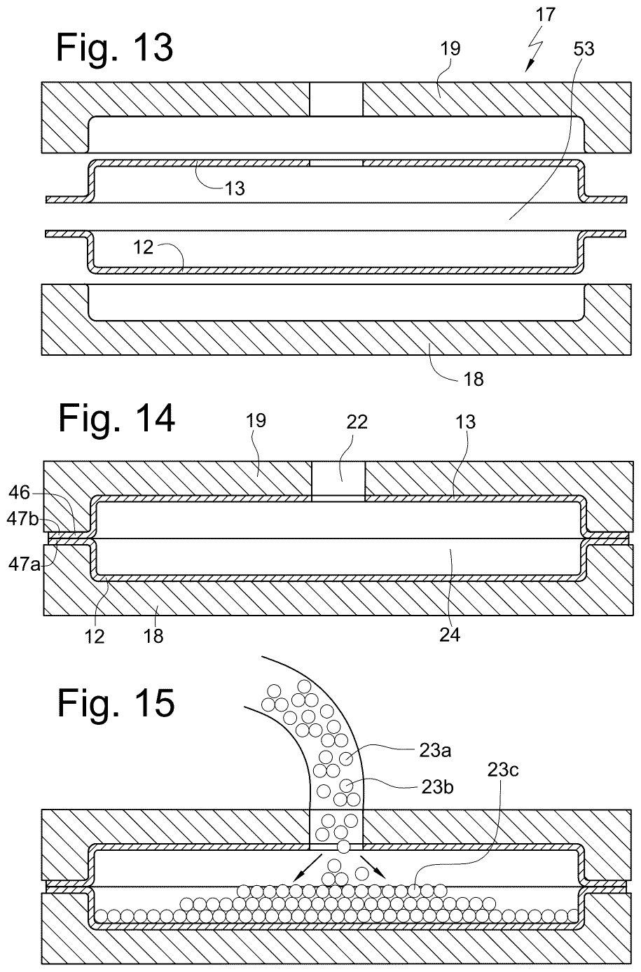

FIG. 13 the tool of FIG. 12 and the first substrate and the second substrate in an intermediate assembly state,

FIG. 14 the closed tool of FIG. 13, wherein the first substrate is placed on the first tool half and the second substrate is placed on the second tool half,

FIG. 15 the process of filling the tool of FIG. 14 with particles,

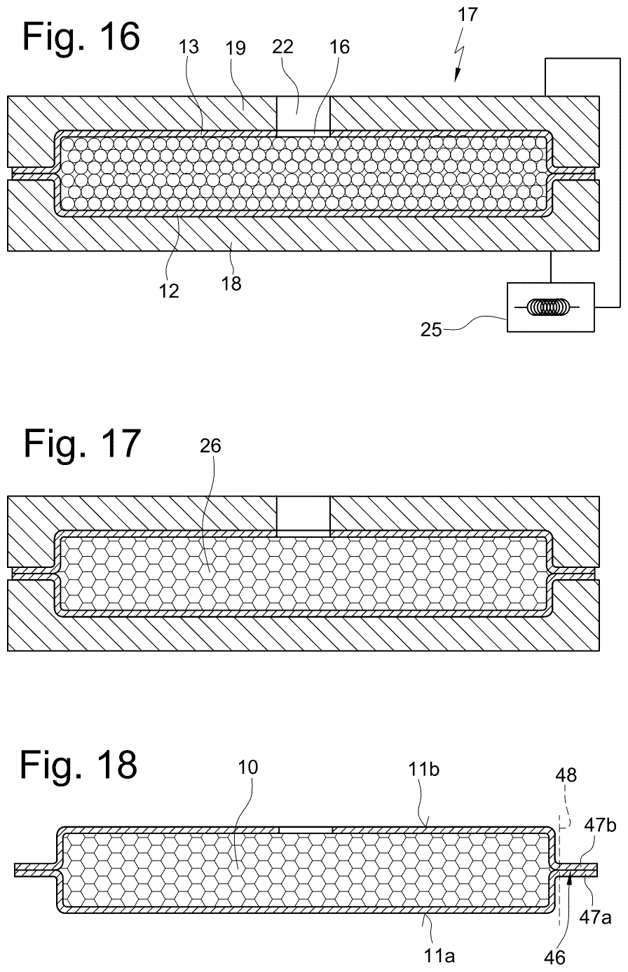

FIG. 16 the heating of the tool,

FIG. 17 the formed structural element made of baked and hardened particle foam mass,

FIG. 18 the structural element shown in FIG. 17 in isolation after removal from the tool in a partially cut schematic view,

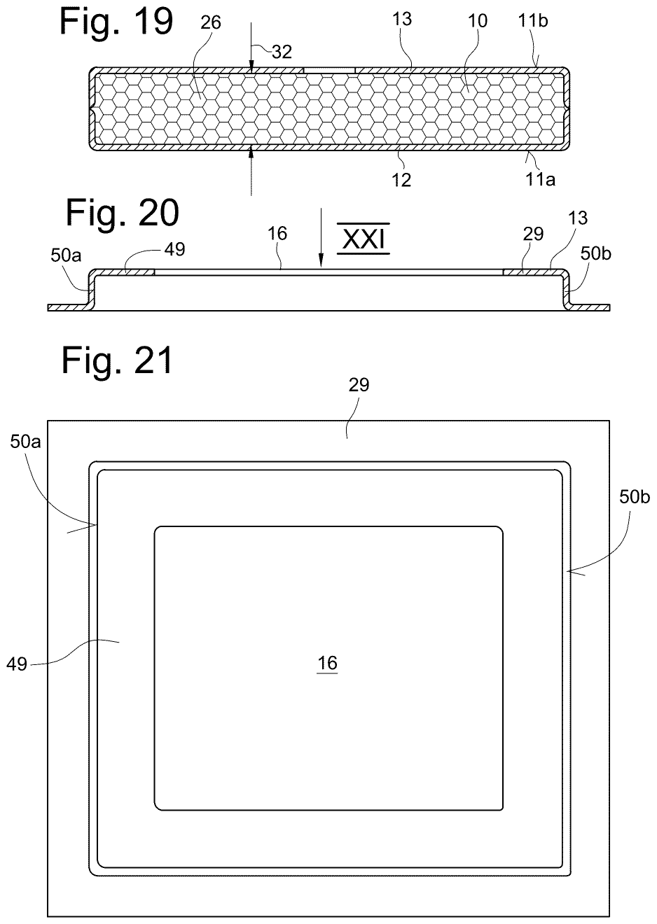

FIG. 19 the structural element of FIG. 18 after separation of material areas of the two substrates, approximately along the separating line shown as a dashed line in FIG. 18,

FIG. 20 another embodiment of a second substrate, which is designed as a ring body,

FIG. 21 the embodiment of FIG. 20 in top view, approximately along the viewing arrow XXI in FIG. 20,

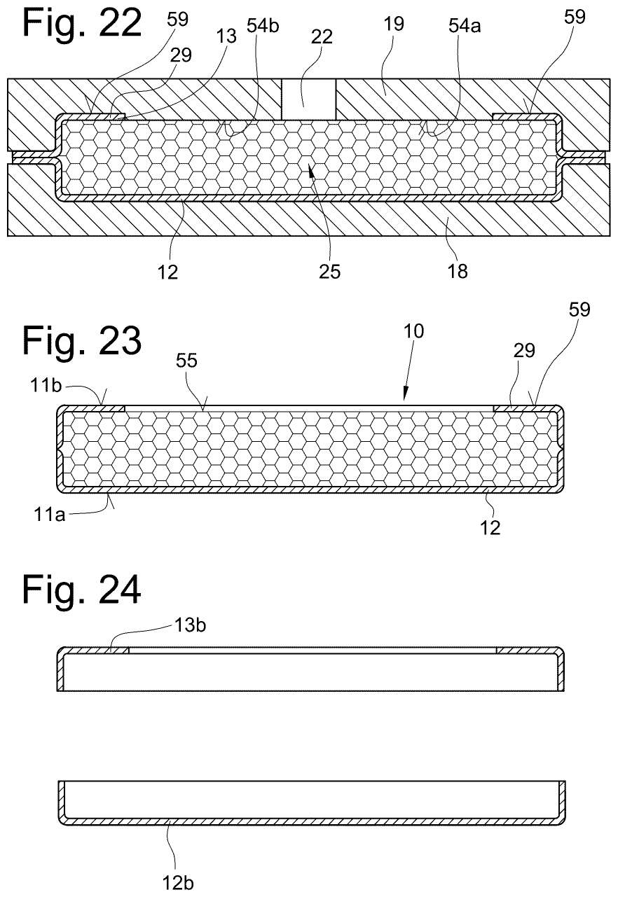

FIG. 22 a closed tool with the first substrate inserted and the embodiment of the second substrate according to FIG. 20,

FIG. 23 an embodiment of a structural element manufactured according to the invention using a second substrate according to FIG. 20, after separating material areas according to FIG. 22,

FIG. 24 modified embodiments of a first substrate and a second substrate,

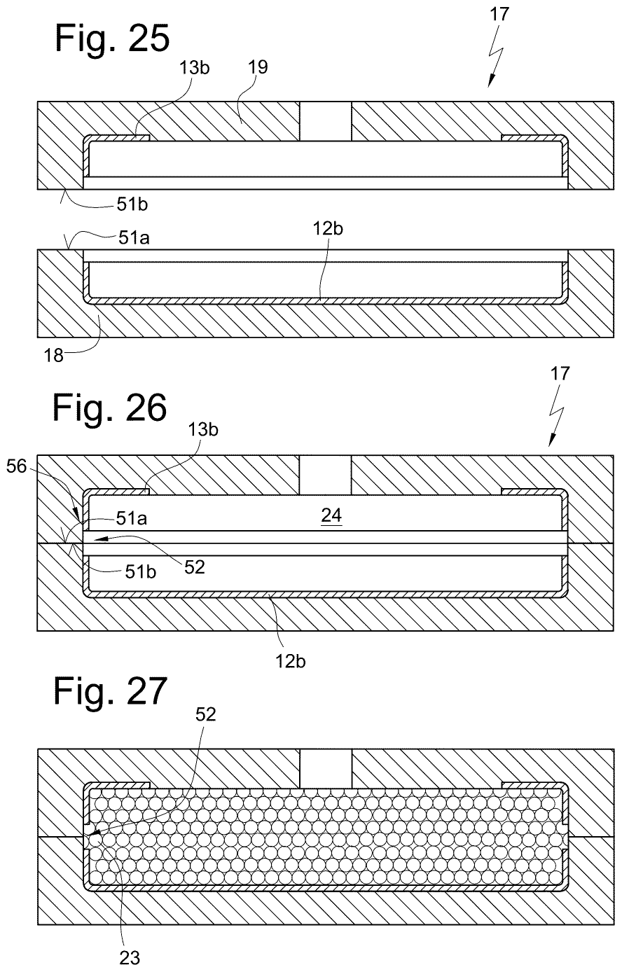

FIG. 25 a tool into which the two substrates are inserted according to FIG. 24, with the tool open.

FIG. 26 the closed tool of FIG. 5,

FIG. 27 the structural element generated using the two substrates according to FIG. 24 after filling and baking the particles,

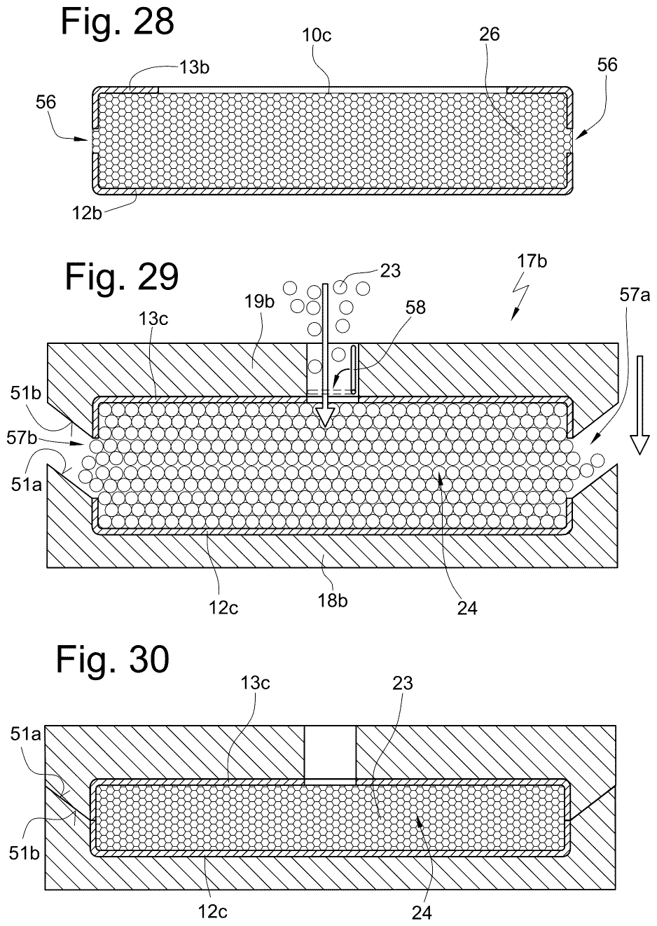

FIG. 28 the finished structural element from FIG. 27 shown alone,

FIG. 29 another example of a tool in the open position in a filled state, in which the two tool halves are spaced apart from each other, this tool providing the possibility of compression and additionally a closure flap for the filling opening.

FIG. 30 the embodiment of the tool of FIG. 29, after the tool has been completely closed under compression of the particles in a hardened state,

FIG. 31 a further embodiment of the invention in a representation according to FIG. 13, with a second substrate designed differently from FIG. 13, wherein the second substrate can dip into an opening of a collar provided by the first substrate,

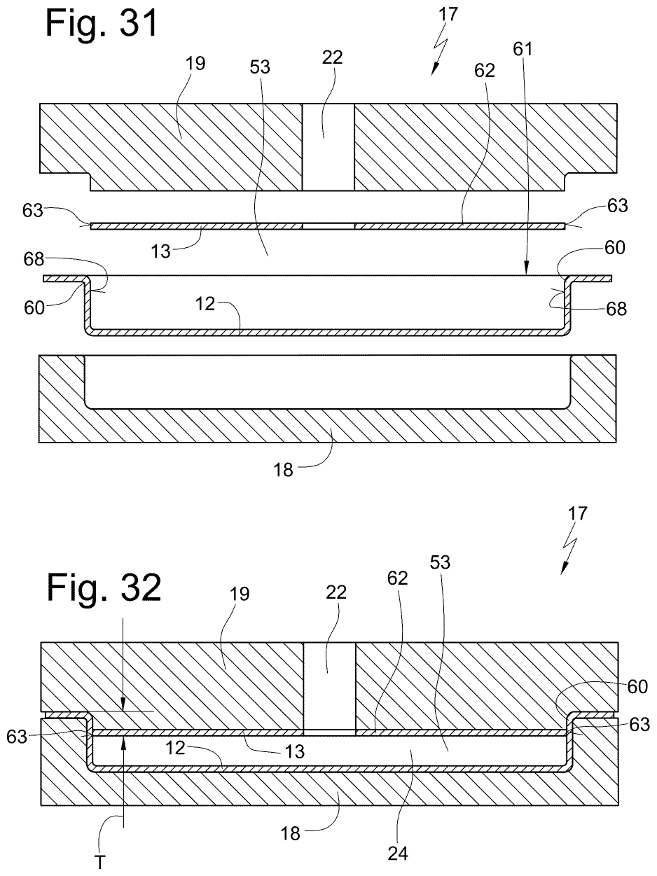

FIG. 32 the embodiment of FIG. 31 in a representation and in a state according to FIG. 14, with the tool closed, before filling,

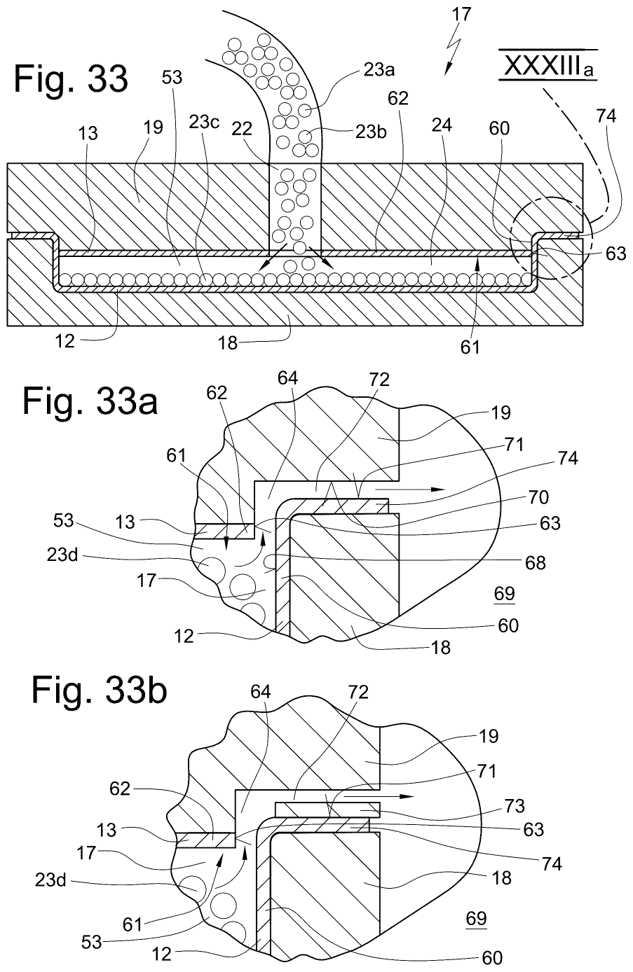

FIG. 33 the embodiment of FIG. 31 in a representation and in a state according to FIG. 14, during filling,

FIG. 33a in an enlarged, partially sectioned, schematic view approximately according to part circle XXXIIIa in FIG. 33, a connection area between the first substrate and the second substrate, illustrating a venting gap,

FIG. 33b in a representation according to FIG. 33a, a modified embodiment with a modified venting gap,

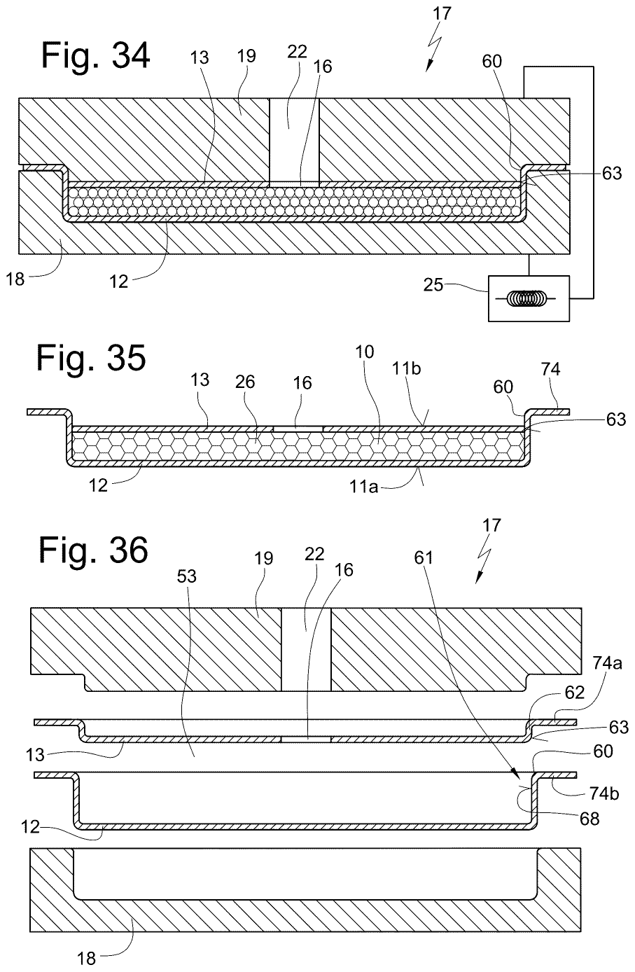

FIG. 34 the embodiment of FIG. 31 in a representation and in a state according to FIG. 16, after filling with particles before heating the tool,

FIG. 35 the embodiment of the finished structural element of FIG. 31 in a single view and in a state according to FIG. 18, after the particles have baked and after removal from the mold,

FIG. 36 in a representation according to FIG. 13, a further embodiment of the invention with two substrates which are shell-shaped and can be nested with one another, wherein the first substrate has a collar which surrounds an opening into which the second substrate with an immersion section can be immersed,

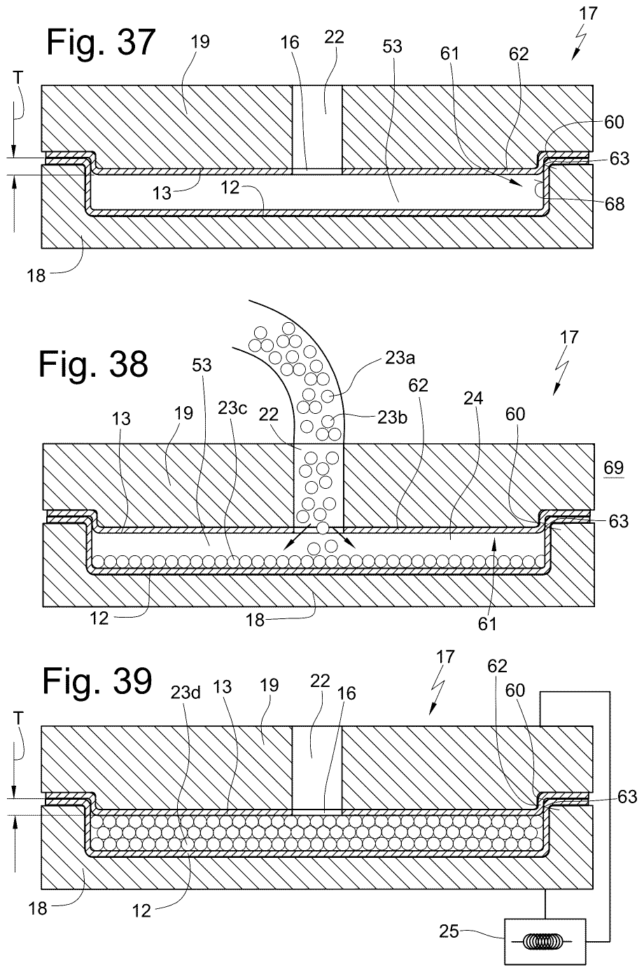

FIG. 37 the embodiment of FIG. 36 in a representation and in a state according to FIG. 14,

FIG. 38 the embodiment of FIG. 36 in a representation and in a state according to FIG. 15,

FIG. 39 the embodiment of FIG. 36 in a representation and in a state according to FIG. 16,

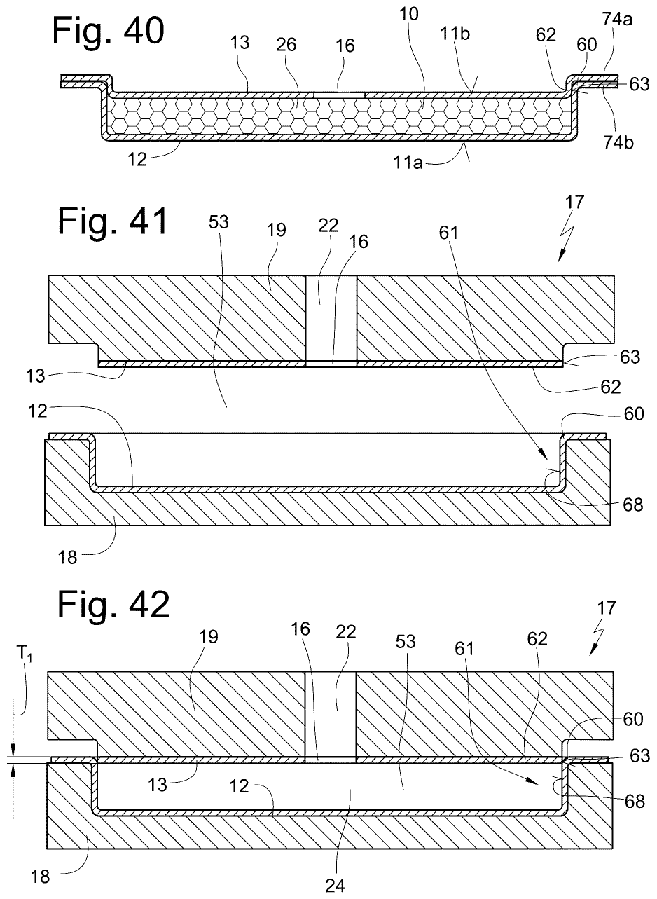

FIG. 40 the manufactured structural element of the embodiment of FIG. 36 in a single view and in a state according to FIG. 18,

FIG. 41 a further embodiment of a device according to the invention in a representation and in a state according to FIG. 31,

FIG. 42 the embodiment of FIG. 41 with a tool in a pre-closing position, wherein the second substrate is immersed in an opening provided by a collar of the first substrate,

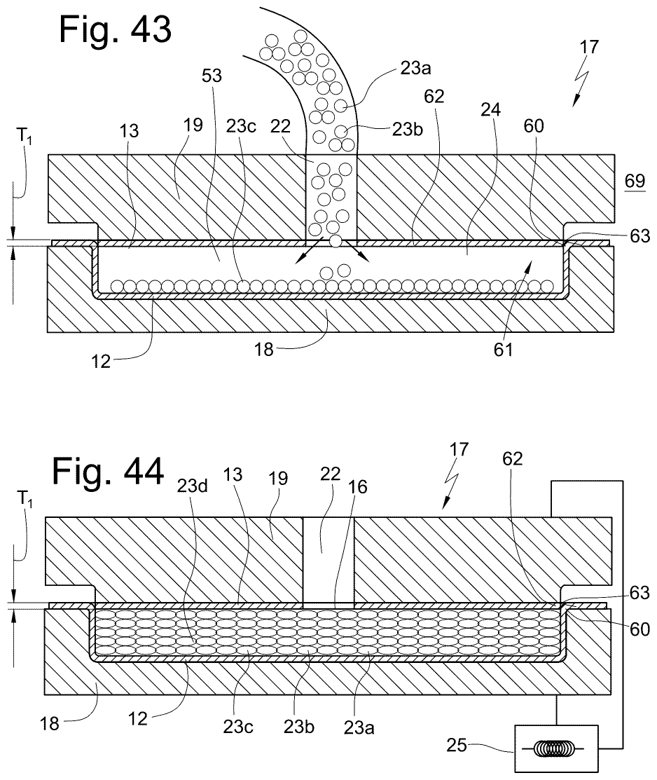

FIG. 43 the tool located in the pre-closing position according to FIG. 42 during filling of the cavity formed by the two substrates with particles of a particle foam,

FIG. 44 the embodiment of FIG. 43 after complete filling with particles and after the particles have melted or softened as a result of a first heating step,

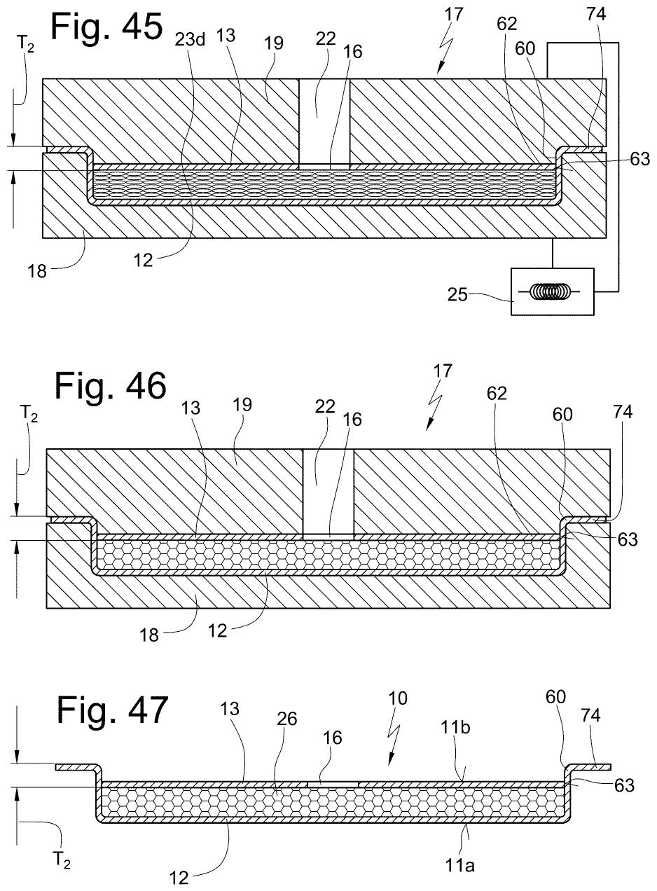

FIG. 45 the embodiment of FIG. 44 with a tool moved from the pre-closing position to a final closing position while compressing the softened particles,

FIG. 46 the embodiment of FIG. 45 after a second heating step and after heating and subsequent baking of the compressed particles of the particle foam mass, and

FIG. 47 the finished structural element shown alone in a view according to FIG. 18.

The embodiments of the invention are explained with reference to the following description of the drawings:

Examples of the invention are described by way of example in the following description of the figures, also with reference to the drawings. For the sake of clarity, identical or comparable parts or elements or areas are designated with the same reference symbols, in some cases with the addition of small letters, even if different examples are concerned.

Features that are only described in relation to one embodiment may also be provided in any other embodiment of the invention within the scope of the invention. Such modified embodiments are also included in the invention, even if they are not shown in the drawings.

All disclosed features are essential to the invention. The disclosure of the application also includes the disclosure content of the associated priority documents (transcript of the preliminary application) as well as the cited publications and the described devices of the prior art in their entirety, also for the purpose of including individual or multiple features of these documents in one or more claims of the present application.

A method for manufacturing a structural element shown in its entirety in the drawings with reference number 10 is illustrated below using the figures.

FIG. 1 shows a container 33 filled with un-foamed particles 34a, 34b, 34c of a foamable particle foam. The filled particles 34a, 34b, 34c are foamed under the influence of the radiant energy of an IR heater 35, as shown in FIG. 1, and reach a considerably increased volume, as shown in FIG. 2. The foamed particles 23a, 23b, 23c are still granular particles, i.e., loose, and thus not connected to each other.

FIG. 2 shows the particles 23a, 23b, 23c in a partially pre-foamed state or in a fully foamed state. The fully foamed particles or pre-foamed particles are reused later, as indicated in FIG. 15.

First, FIGS. 3 to 6 are used to explain the production of an embodiment of a first substrate 12.

FIG. 3 shows a first deep-drawing tool 27 in the open state, which has a tool upper part 36 and a tool lower part 37. FIG. 3 shows a starting material 38 for a first substrate 12, which is still provided in a flat, essentially web-shaped or plate-shaped state. The starting material 38 is deep-drawn as a result of the tool closing.

FIG. 4 shows the closed tool state and the deep-drawn first substrate 12. FIG. 12 shows this substrate 12 in isolation. The substrate 12 comprises a bottom wall 39 and surrounding side walls 40a, 40b. The contour is, of course, arbitrary. In particular, the first substrate 12 is shell-shaped.

FIG. 7 to illustrate the production of an embodiment of a second substrate 13.

FIG. 7 shows the open state of a second deep-drawing tool 28 and a flat-lying starting material 43 for the second substrate 13 to be produced.

FIG. 8 shows the second deep-drawing tool 28 in the closed state. Again, the geometry of the tool shape is imprinted on the starting material 43 as a result of the deep-drawing process. FIG. 8 shows the deep-drawn second substrate 13.

This second substrate 13 is shown in FIG. 9 in isolation and in FIG. 10 in a top view.

The second substrate 13 is also essentially shell-shaped. The second substrate 13 comprises a bottom wall 44 and side wall sections 45a, 45b.

FIG. 11 shows that a central opening, known as the through-opening 16, is incorporated into the manufactured second substrate 13. The through-opening 16 is explained below.

In further embodiments of the invention, which are not shown, the second substrate 13 may also have several openings 16. It should be noted that in the vast majority of embodiments of the invention, the first substrate 12 does not have an opening.

It should be noted that the through-opening 16 can also be incorporated into the second substrate 13 during the deep drawing process.

It should also be noted at this point that FIGS. 1 to 10 describe the production of a first substrate 12 and a second substrate 13 by a deep drawing process.

However, the invention also includes alternative embodiments in which the first substrate 12 and/or the second substrate 13 are provided by a plastic injection molded part.

The first substrate 12 has a wall thickness 30 and the second substrate 13 has a wall thickness 31.

The following description uses the embodiments shown in FIGS. 12 to 19 to explain how a structural element 10 according to the invention is manufactured using the method according to the invention, using the embodiments of a first substrate 12 and a second substrate 13 shown in FIGS. 1 to 11.

FIG. 12 shows a tool 17 referred to as a foaming tool.

The foaming tool 17 comprises a first tool half 18 and a second tool half 19. FIG. 12 shows the tool 17 in the open state.

The first tool half 18, which according to the figures could also be referred to as the lower tool, and the second tool half 19, which according to the figures could also be referred to as the upper tool, are movable relative to each other.

The corresponding tool carriers and movement units are not shown in the figures.

The first tool half 18 comprises a first inner contour 20. This first inner contour 20 is complementary in shape to a first outer contour 14 of the first substrate 12. The second tool half 19 comprises a second inner contour 21. The second inner contour 21 is complementary in shape to a second outer contour 15 of the second substrate 13.

The second tool half 19 comprises a second inner contour 21. The second inner contour 21 is complementary in shape to a second outer contour 15 of the second substrate 13.

The two substrates 12, 13 are thus provided with a geometry that corresponds to the geometry of the tool halves 18 and 19 of the foaming tool 17.

FIG. 13 shows an intermediate assembly state in which the two substrates 12, 13 are positioned in an interior space 53 of the tool 17.

The two substrates 12, 13 are positioned when the tool 17 is open.

FIG. 14 shows the foaming tool 17 in the closed state with substrates 12, 13 inserted.

The first substrate 12 lies with its outer peripheral surface against the first tool half 18 and the second substrate 13 lies with its outer peripheral surface against the inner peripheral surface of the second tool half 19.

It is important that the through-opening 16 of the second substrate 13, as shown in FIGS. 13 and 14, is aligned with the filling opening 22 in the second tool half 19 due to the arrangement of the second substrate 13 in the second tool half 19.

The filling opening 22 serves to supply particles 23a, 23b, as shown in FIG. 15 below.

The second mold half 19 may also have several filling openings 22, which are not shown. These are then aligned with one of several openings 16 in the second substrate 13.

The filling opening 22 of the second tool half 19 is connected to a supply for the particles 23a, 23b, 23c via a conduit system not shown. As indicated by the embodiment shown in FIG. 29, the filling opening 22 can also be designed to be opened or closed by means of one or more closing devices 58.

The particles 23a, 23b, 23c can be transferred from the supply, which is not shown, to the foaming tool 17, in particular by means of compressed air.

Once the two substrates 12, 13 have been inserted into the corresponding tool halves 18, 19, the tool 17 can be closed. The cavity 24 formed by the two substrates 12, 13 can now be filled with particles 23a, 23b, 23c.

FIG. 15 shows the filling process.

When a corresponding filling volume is reached in the cavity, the further supply of particles 23a, 23b, 23c is stopped.

As shown in FIG. 16, the tool 17 is equipped with a heating element 25. The heating element 25 can subject the mold 17 to temperature cycling in particular. In particular, temperatures above a melting temperature or a softening temperature of the particle foam, as well as temperatures below a melting temperature or a softening temperature of the particle foam, can be achieved.

In particular, depending on the selected particle foam material, the tool 17 can be brought to a higher temperature along a temperature ramp, remain there for a certain period of time, and then, if the corresponding adjustable heating duration has been reached, be cooled again.

For this purpose, the tool 17, namely both the first tool half 18 and the second tool half 19, may be provided with channels, not shown in the figures, through which heated water and/or cooled water or another heating or cooling medium can flow.

Tool 17 may be designed, which is also not shown in the figures, so that it can be subjected to rapid temperature changes.

As a result of heating the tool 17 to a temperature above the melting temperature, the particles 23a, 23b, 23c introduced in granular form into the cavity 24 can melt and bake together with each other and with the substrates 12, 13.

The heat transfer takes place from the mold halves 18, 19 inward, i.e., across the first substrate 12 and across the second substrate 13, into the cavity 24.

It is noteworthy that no water vapor is required for melting and baking the particles 23a, 23b, 23c to form a particle foam mass 26. The particle foam mass 26 can therefore be baked completely “dry.” In particular, no water vapor needs to be evacuated and no residual moisture remains in the structural element.

FIG. 16 shows an embodiment in which a through-opening 16 is arranged in the second substrate 13 and a filling opening 22 is arranged in the second mold half. The invention also encompasses cases in which several through-openings 16 are arranged in the second substrate 13 and several filling openings 22 are arranged in the second mold half 19.

It should also be noted that the terms “first tool half 18” and “second tool half 19” are to be understood functionally and describe a separation of the tool 17 into two parts. However, this does not necessarily mean two half tools.

When the particle foam mass 26 has been heated for a prescribed period of time and the particle foam mass has melted homogeneously, the tool 17 is cooled. The particle foam mass 26 then solidifies and hardens.

After a specified holding time, the tool 17 can be opened by moving the two tool halves 18, 19 away from each other.

The molded part, i.e., the finished structural element 10, can then be removed.

FIG. 18 shows the removed structural element in a single view.

In the embodiment shown in FIGS. 12 to 18, it can be seen that the two substrates 12, 13 have protruding areas 47a, 47b in their contact area 46. These can be separated, for example, along a separating line 48 shown in FIG. 18.

FIG. 19 shows the finished structural elements 10, which have been processed accordingly, in isolation.

The finished structural element has a wall thickness 32 of a particle foam mass 26 that has been cured.

The finished structural element 10 is very lightweight and rigid.

The outward-facing surfaces of the first substrate 12 and the second substrate 13 form the surfaces 11a, 11b of the structural element 10. These are very high quality and can provide, for example, “class A” surfaces.

FIGS. 20 to 23 illustrate a further embodiment of a method according to the invention and a structural element 10 according to the invention.

The difference to the previously described embodiment is that, in this embodiment, the second substrate 13 is formed by a ring body 29.

This has a large central opening which provides the through-opening 16.

FIG. 22 illustrates that, in this embodiment, inner wall regions 54a, 54b of the second tool half 19 also delimit the cavity 24.

These inner wall areas 54a, 54b can also be arranged flush with the outer peripheral surface 59 of the second substrate 13, unlike in FIG. 22.

The finished structural element 10 has, as shown in FIG. 23, a surface on its lower side 11a (relative to FIG. 23) which corresponds to the structural element 10 shown in FIG. 19.

The rear side 11b of the structural element is formed by a ring body 29 and is formed in the central region by bare wall areas 55 of the particle foam mass.

The embodiment shown in FIGS. 24 to 28 illustrates a further embodiment of a method and a structural element 10 according to the invention. Here, slightly modified first substrates 12 and second substrates 13 are provided, which are referred to as the first substrate 12b and the second substrate 13b in the embodiment of FIGS. 24 to 28.

In the embodiment, it can be seen in particular from FIGS. 25 to 26 that the first tool half 18 and the second tool half 19 have tool surfaces 51a, 51b which come into contact when the tool 17 is closed, as shown in FIG. 26.

The contact area 56 of the two substrates 12b, 13b thus comprises a free space 52 (see FIG. 26) which also defines the cavity 24. As explained in FIG. 27, this free space 52 is also filled with particles 23a, 23b, 23c.

In the impact area 56, the structural element 10c thus also has a bare particle foam mass 26 that is not covered by substrate material, as shown in FIG. 28.

The compression of the introduced particles 23 is explained using the examples shown in FIGS. 29 to 30.

FIG. 29 shows the tool 17b in a partially closed state in which the two tool halves 18b, 19b are still separated from each other. The cavity 24 is now filled with particles 23.

In the area of the tool grooves 57a, 57b, a device (not shown) may be provided to prevent the particles 23 from escaping from the cavity 24.

After the cavity 24 has been filled with particles 23, a closing device 58 can be activated by a control system (not shown) which closes the filling opening 22.

Starting from the tool state 17 shown in FIG. 29, a further tool closing movement can be carried out ( ), for example to a state shown in FIG. 30, in which the tool surfaces 51a, 51b are in contact with each other.

In the course of this final tool closure, the cavity 24 is reduced in size, thereby compressing the particles 23.

In all embodiments, the two tool halves 18, 19 are heated to a predetermined temperature for a certain period of time, as described above, and then this temperature is maintained, followed by cooling of the two tool halves 18, 19 to a temperature below the softening temperature of the particle foam mass.

A further embodiment of the invention is explained below with reference to FIGS. 31 to 35:

In contrast to the embodiment shown in FIGS. 13 to 18, the second substrate 13 is not shell-shaped, but is provided by a flat body or by a substantially flat body.

FIGS. 31 to 35 show the second substrate 13 in a flat design. The invention also encompasses cases in which the second substrate 13 has any contour in space.

A special feature of this embodiment is that the first substrate 12 has a collar 60 or a collar region 60 which surrounds an opening 61.

The second substrate 13 can be inserted or plugged into this opening 61 with an immersion section 62.

The second substrate 13 thus dips—at least slightly—into an opening 61 provided by the collar 60 of the first substrate 12.

FIG. 31 shows this embodiment of the invention in a schematic pre-assembly position. As in the embodiments described above, the first substrate 12 is fixed to the first tool half 18 and the second substrate 13 is fixed to the second tool half 19. As described in the previous embodiments and as also provided in the embodiments described below, the contour of the tools 18, 19 is again adapted to the contour of the substrates 12, 13.

After the substrates 12, 13 have been secured to the corresponding tool halves 18, 19, the two tool halves 18, 19 are moved toward each other. FIG. 32 shows the state in which the tool 17 is closed. In this state, the second substrate 13 is at least partially immersed in the first substrate 12.

The immersion depth is indicated in FIG. 32 with the reference symbol T.

The immersion depth T can be 0 to a few millimeters, and if necessary also one or more centimeters.

The invention also covers cases where the first substrate 12 is merely placed against the second substrate 13 when the tool 17 is closed, i.e., it is only slightly immersed or begins to immerse.

A venting gap, which will be explained later, may also be provided between the two substrates 12, 13, in particular in the form of a continuous annular gap 64.

Starting from a state as shown in FIG. 32, the cavity 24 provided by the two substrates 12, 13 can be filled with particles 23a, 23b, 23c, 23d, 23e. FIG. 33 shows the tool 17 and the two substrates 12, 13 at the moment of filling.

The cavity 24 is completely filled with particles 23a, 23b, 23c, 23d, 23e, which is not shown in FIG. 33. The filling with particles takes place under high pressure and the particles are transported with the aid of compressed air. The compressed air can escape through a vent gap 64 not shown in FIG. 33.

After filling, the tool 18, 19 is heated. In particular, both tool halves 18, 19 are tempered.

This is indicated in FIG. 34. The particles melt. The mold 17 is then cooled and opened. FIG. 35 shows the structural element 10 produced in this way and removed from the mold 17.

The embodiment shown in FIG. 33a shows a special feature:

In contrast to the embodiment shown in FIG. 33, this embodiment may have a venting gap 64, as explained by the part circle XXXIIIa in FIG. 33. The special feature of this venting gap 64 is that it is dimensioned such that air can escape, thus allowing the cavity 24 to be filled with particles 23a, 23b, 23c, 23d, 23e under high pressure. However, the vent gap 64 is dimensioned so small that the particles 23a, 23b, 23c, 23d, 23e cannot pass through the vent gap 64 into the outer space 69, but have a diameter that is too large for them to pass through. This ensures that, despite the arrangement of a vent gap 64, the particles 23a, 23b, 23c, 23d, 23e do not leave the cavity 24.

The vent gap 64 can, for example, extend along the entire collar 60 and, in particular, extend circumferentially between an inner circumferential surface 68 of the collar 60 and an edge region 63 of an immersion section 62 in the direction of circumference.

In this case, the venting gap 64 is designed as an annular gap.

Alternatively, however, the venting gap 64 may also be designed in the form of one or more venting openings or venting bores, or may be designed only in sections or segments.

FIG. 33a shows that the venting gap 64 communicates between the interior 53 of the foaming tool 17 and the exterior 69. This connection can extend between a lower side 70 of the mold half 19 and an upper side 71 of an outer section 74 of the first substrate 12 in the form of a section 72, as shown, for example, in FIG. 33a.

This section 72 of the venting gap 64, which is shown in FIG. 33a, can extend equally around the circumference. However, the section 72 can also be designed as a single bore or as a plurality of bores.

FIG. 33b illustrates an alternative embodiment in which a section 72 of a venting gap 64 is designed as a bore so that a material region 73 of the tool 19 rests directly on the upper side 71 of the first substrate 12. Here, the venting gap 64 may, for example, have several outlet openings or holes that connect the interior 53 of the foaming tool 17 to the exterior 69.

In the embodiment shown in FIGS. 36 to 40, the first substrate 12 and the second substrate 13 are each shell-shaped, but arranged relative to each other in such a way that the two substrates 12, 13 can partially nest with each other. Such a nested, i.e., interlocking state is shown, for example, in FIG. 37.

Again, the second substrate 13 comprises an immersion section 62 with an edge 63. With its immersion section 62, the second substrate 13 can immerse itself in an opening 61 of the first substrate 12 provided by a collar 60 of the first substrate 12 during a tool closing movement.

Again, a vent gap 64, which is not shown in the figures, may be provided, which in this embodiment also extends between an inner peripheral surface 68 of the collar 60 and an edge 63 of the immersion section 62.

Further on, the vent gap 30 64, which is not shown, connects the interior 53 of the foaming tool 17 to the exterior 69 so that compressed air can escape when the cavity 24 is filled with particles 23a, 23b, 23c, 23d, 23e. Here too, the vent gap 64 is dimensioned so small that the particles 23a, 23b, 23c, 23d, 23e cannot escape from the cavity 24 through the vent gap 64.

All embodiments of FIGS. 31 to 47 show a first substrate 12 and/or a second substrate 13 with an outer section 74a, 74b, which, in the finished state of the respective structural element 10, for example according to FIG. 35, FIG. 40 or FIG. 47, protrudes outward beyond the contour of the actual structural element 10. These outer sections 74, 74a, 74b can also be separated according to the invention.

Another embodiment of the invention will now be explained with reference to FIGS. 41 to 47:

At first glance, the embodiment shown in FIG. 41 corresponds to the embodiment shown in FIG. 31.

FIG. 42 shows that, after the first substrate 12 has been fixed to the first tool half 18 and the second substrate 13 has been fixed to the second tool half 19, the tool 17 can be moved into a pre-closing position shown in FIG. 42. In this position, the second substrate 13 is positioned close to the first substrate 12 and dips slightly, with the immersion depth T1 shown in FIG. 42, with its immersion section 62 into the opening 61 of the collar 60 on the first substrate 12. FIG. 42 shows the cavity 24 formed by the two substrates 12, 13 in the unfilled state.

Subsequently, filling with particles can take place as shown in FIG. 43. Again, a vent gap 64, which is not shown, can provide for the escape of compressed air.

FIG. 44 shows the tool 17 with the cavity 24 completely filled with particles 23a, 23b, 23c, 23d, 23e, wherein a first heating step, initiated by the heating device 25, has already been carried out, which has melted or softened the particles 23a, 23b, 23c, 23d, 23e. FIG. 44 indicates this by the elliptical shape of the individual particles 23a, 23b, 23c, 23d, 23e, in contrast to the circular shape shown in FIG. 43.

The particles are therefore softened or melted as a result of the heating of the two tool halves 18, 19.

Starting from a position of the tool 17 according to FIG. 44 with a softened state of the particles 23a, 23b, 23c, 23d, 23e, a further compression stroke of the tool 17 can now be carried out according to the invention. In this case, the immersion section 62 penetrates deeper into the opening 61. FIG. 45 shows the tool 17 after this compression stroke has been performed. The immersion depth of the immersion section 62 into the opening 61 is designated by the reference symbol T2.

As a result of this compression stroke, the softened particle foam mass is compressed. Compression can take place to a fraction of the volume of the particle foam mass before the compression stroke. For example, a volume reduction to half, one third, or one quarter can take place. Accordingly, the density of the softened particle foam mass is increased.

FIG. 45 indicates that, in the case of compressed, softened particle foam mass, the heating element 25 performs a further heating step. The particles are now finally melted and bonded together. The mold is then cooled.

FIG. 46 shows the compressed, cured particle foam mass. After removal of the molded part thus formed, the structural element 10 is further processed as necessary in accordance with FIG. 47. For example, the outer sections 74 can be separated off.

All embodiments of the invention illustrate the cured particle foam mass as an essentially cuboid body. However, the invention also encompasses any spatial contours.

The structural element 10 may also comprise areas with cured particle foam mass with different wall or thickness areas.

In particular, screw fastenings or domes may also be arranged in the particle foam mass 26, for example to form reinforcement areas. The structural element 10 therefore does not necessarily have a constant wall thickness throughout.

1-40. (canceled)

41. A method for manufacturing a thin-walled structural element in a lightweight sandwich construction with a high-quality surface, comprising the steps of:
a) providing a first film-like substrate having a first outer contour;
b) providing a second film-like substrate having a second outer contour, which has at least one through-opening;
c) providing an openable and closable tool comprising a first tool half and a second tool half, wherein the second tool half has at least one filling opening, wherein the first tool half has a first inner contour complementary in shape to the first outer contour and the second tool half has a second inner contour complementary in shape to the second outer contour;
d) arranging the first substrate in the first tool half with the tool open;
e) arranging the second substrate in the second tool half with the tool open so that the through-opening and the filling opening are aligned with one another;
f) closing the tool;
g) providing granular starting material formed as loose particles of a foamable particle foam, such as EPS, EPE, ABS, PPSU, PESU, PSU or PEEK;
h) feeding the particles through the filling opening and the through-opening into a cavity bounded by the two substrates;
i) heating the two tool halves;
j) baking the particles to form a homogeneous, thermally curable particle foam as a result of heat transfer from the tool through the two substrates into the cavity;
k) cooling the two tool halves;
l) allowing the particle foam to cure; and
m) opening the tool and removing the molded part thus formed.

42. A method for producing a thin-walled structural element in a lightweight sandwich construction with a high-quality surface, comprising the steps of:
a) providing a first film-like substrate;
b) providing a second film-like substrate which has at least one through-opening;
c) providing an openable and closable tool comprising a first tool half and a second tool half, wherein the second tool half has at least one filling opening;
d) arranging the first substrate in or on the first tool half when the tool is open;
e) arranging the second substrate in or on the second tool half when the tool is open so that the through-opening and the filling opening are aligned with one another;
f) closing the tool;
g) providing granular starting material formed as loose particles of a foamable particle foam, such as EPS, EPE, ABS, PPSU, PESU, PSU or PEEK;
h) feeding the particles through the filling opening and the through-opening into a cavity bounded by the two substrates;
i) heating the two tool halves;
j) baking the particles to form a homogeneous, thermally curable particle foam as a result of heat transfer from the yeol tool through the two substrates into the cavity;
k) cooling the two tool halves;
l) allowing the particle foam to cure; and
m) opening the tool and removing the molded part thus formed.

43. The method according to claim 41, wherein step a) is preceded by deep drawing of the first substrate from a flat state.

44. The method according to claim 41, wherein the first substrate is provided by a plastic injection molded part.

45. The method according to claim 41, wherein step b) is preceded by deep drawing of the second substrate from a flat state.

46. The method according to claim 41, wherein the second substrate is provided by a plastic injection molded part.

47. The method according to claim 41, wherein the first substrate and/or the second substrate is a thermoplastic material or comprises a co-extrudate of ABS and PMMA or of ABS, polycarbonate and PMMA.

48. The method according to claim 41, wherein the first substrate is formed continuously over its entire surface.

49. The method according to claim 41, wherein the second substrate is formed continuously over its entire surface, except for the at least one through-opening.

50. The method according to claim 41, wherein the second substrate is formed by a ring body.

51. The method according to claim 41, wherein step g) comprises pre-foaming particles outside the tool and step j) comprises feeding partially foamed or completely foamed particles.

52. The method according to claim 41, wherein step j) comprises completely foaming or finally foaming the particles.

53. The method according to claim 41, wherein step f) comprises only partially closing the tool, wherein step h) for achieving compression of the supplied particles is followed by a further closing movement of the tool.

54. The method according to claim 41, wherein the first substrate and/or the second substrate has a wall thickness between 0.05 mm and 13 mm, or between 1 mm and 5 mm.

55. The method according to claim 41, wherein the cured particle foam has a wall thickness between 0.5 cm and 2 cm, or between 0.5 cm and 1.5 cm.

56. The method according to claim 41, wherein the structural element is designed as a vehicle part for a motor vehicle or for a commercial vehicle or for a caravan vehicle, or as an interior trim part, a load compartment cover, a trim part, an engine hood, a roof element or roof segment, hood, sleeping compartment extension, vehicle wall, or vehicle wall element.

57. The method according to claim 41, wherein the starting material is provided from expandable EPS, PP, ABS, PPSU, PSU, or PEEK.

58. The method according to claim 41, wherein the following step is carried out between steps e) and f):
n) positioning reinforcing elements, in particular of the type of tensile anchors, for example of the type of tapes, in the cavity between the first substrate and the second substrate, wherein after the particles are fed into the cavity, they envelop the reinforcing elements.

59. The method according to claim 42, wherein one substrate of the two substrates is shell-shaped and has a collar surrounding an opening, wherein, as a result of the execution of step f), the other substrate of the two substrates can be inserted into the opening.

60. The method according to claim 59, wherein, after performing step f), the collar of one substrate surrounds an edge of the other substrate.

61. The method according to claim 59, wherein a vent gap remains between the collar of one substrate and the edge of the other substrate after the tool is closed.

62. The method according to claim 41, wherein both substrates are shell-shaped and nest together.

63. A method for manufacturing a thin-walled structural element in a lightweight sandwich construction with a high-quality surface, comprising the steps of:
a) providing a first film-like substrate;
b) providing a second film-like substrate which has at least one through-opening;
c) providing an openable and closable tool comprising a first tool half and a second tool half, wherein the second tool half has at least one filling opening;
d) arranging the first substrate in or on the first tool half when the tool is open;
e) arranging the second substrate in or on the second tool half when the tool is open so that the through-opening and the filling opening are aligned with one another;
f) moving the tool into a pre-closing position;
g) providing granular starting material formed as loose particles of a foamable particle foam, such as EPS, EPE, ABS, PPSU, PESU, PSU or PEEK;
h) feeding the particles through the filling opening and the through-opening into a cavity bounded by the two substrates;
i) heating the two tool halves and melting the particles as a result of heat transfer from the mold through the two substrates into the cavity;
j) moving the tool to a final closing position and compressing the melted particles;
k) further heating of the two tool halves and baking of the particles into a homogeneous, curable particle foam as a result of heat transfer from the tool through the two substrates into the cavity;
l) cooling the two tool halves;
m) allowing the particle foam to cure; and
n) opening the tool and removing the molded part thus formed.

64. The method according to claim 63, wherein, as a result of carrying out step j), the particles are compressed to a density which is at least or approximately twice as high, or at least or approximately three times as high, or at least or approximately four times as high as the density of the particles in the uncompressed state.

65. The method according to claim 63, wherein, as a result of performing step j), the particles are compressed to a density of more than or approximately 100 kg/m³, or to a density of more than or approximately 150 kg/m³, or to a density of more than or approximately 200 kg/m³.

66. A thin-walled structural element in a lightweight sandwich construction with a high-quality surface, comprising a cured particle foam which has a first substrate on a first side and a second substrate on a second side facing away from the first side.

67. The thin-walled structural element according to claim 66, wherein each of the two substrates is provided by a film with a wall thickness between 0.2 mm and 13 mm, or between 1 mm and 5 mm.

68. The thin-walled structural element according to claim 66, wherein the cured particle foam has a wall thickness between 0.5 cm and 2 cm, or between 0.8 cm and 1.5 cm.

69. The thin-walled structural element according to claim 66, wherein the particle foam is foamed against the two substrates.

70. The thin-walled structural element according to claim 66, wherein the first substrate is a deep-drawn part.

71. The thin-walled structural element according to claim 66, wherein the second substrate is a deep-drawn part.

72. The thin-walled structural element according to claim 66, wherein the first substrate is a plastic injection molded part.

73. The thin-walled structural element according to claim 66, wherein the second substrate is a plastic injection molded part.

74. The thin-walled structural element according to claim 66, wherein the first substrate and/or the second substrate consists of a thermoplastic material, or comprises a co-extrudate of ABS or PMMA or of ABS, polycarbonate and PMMA.

75. The thin-walled structural element according to claim 66, wherein the first substrate is formed continuously over the entire surface.

76. The thin-walled structural element according to claim 66, wherein the second substrate is formed continuously over the entire surface, except for the at least one opening.

77. The thin-walled structural element according to claim 66, wherein the second substrate is formed by a ring body.

78. The thin-walled structural element according to claim 66, wherein the structural element is a vehicle part for a motor vehicle or for a commercial vehicle or for a caravan vehicle, or an interior trim part, a load compartment cover, a trim part, an engine hood, a roof element or a roof segment, hood, sleeping compartment extension, vehicle wall, or vehicle wall element.

79. The thin-walled structural element according to claim 66, wherein the starting material is provided from expandable EPS, PP, PPSU, ABS, PSU, or PEEK.

80. The thin-walled structural element according to claim 66, wherein the particle foam has a density of more than or approximately 100 kg/m³, in particular a density of more than or approximately 150 kg/m³, and further in particular a density of more than or approximately 200 kg/m³.
